(19) United States
(12) Patent Application Publication
(10) Pub. No.: US 2007/0153471 A1
(43) Pub. Date: Jul. 5, 2007

(54) MOUNTING APPARATUS FOR DATA STORAGE DEVICE OF COMPUTER SYSTEM

(75) Inventors: Yun-Lung Chen, Tu-Cheng (TW); Jin-Feng Yao, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,109

(22) Filed: Jun. 23, 2006

(30) Foreign Application Priority Data
Dec. 23, 2005 (CN) 200520121163.1

(51) Int. Cl. G06F 1/16; E21F 17/02

(52) U.S. Cl. 361/685; 248/58

(57) ABSTRACT

A mounting apparatus for a data storage device (50) with a mounting hole (522) defined includes a bracket (20) for accommodating the data storage device, and a locking member (30) for securing the data storage device in the bracket. The bracket includes a side plate (26). A through hole (276) is defined in the side plate. A positioning clip (272) is formed on the side plate. The locking member is movably attached to the side plate. A resilient securing clip (342) is formed on the locking member for engaging with the positioning clip. A locking pin (36) is formed on the locking member for engaging into the mounting hole of the data storage device through the through hole. When the locking member is moved toward the side plate, the securing clip engages with the positioning clip and the locking pin engages into the mounting hole.

### FIELD OF THE INVENTION

The present invention relates to mounting apparatuses, and more particularly to a mounting apparatus for a data storage device of a computer system.

### DESCRIPTION OF RELATED ART

Nowadays, to allow convenient installation of a data storage device of a computer system, a pair of rails is usually provided. The rails are assembled to a pair of sidewalls of the data storage device, and then together inserted into a bracket of the computer system, between a pair of side plates of the bracket. However, the rails will increase space respectively between the sidewalls of the data storage device and the side plates of the bracket, thereby reducing EMI-proof (Electro Magnetic Interference, EMI) capability of the computer system.

Another kind of mounting apparatus includes an anchor plate coupled to two struts located on a drive installation rack. The anchor plate has stub shafts on the left side and the right side to pivotally engage with an actuating member. The anchor plate further has anchor stubs corresponding to anchor holes formed on the drive installation rack. Each strut is coupled with a restoring spring. The actuating member has a driving lever on an outer side and a driven end extending from an inner side to enable the driving lever to reach a return position when moved. However, the structure of the mounting apparatus is very complicated.

What is needed, therefore, is a mounting apparatus with a simple structure for convenient installation and removal of a data storage device of a computer system.

### SUMMARY OF THE INVENTION

A mounting apparatus for a data storage device with at least one mounting hole defined includes a bracket for accommodating the data storage device, and a locking member for securing the data storage device in the bracket. The bracket includes a side plate. At least one through hole is defined in the side plate. A positioning clip is formed on the side plate. The locking member is movably attached to the side plate. A resilient securing clip is formed on the locking member for engaging with the positioning clip. At least one locking pin is formed on the locking member for engaging into the at least one mounting hole of the data storage device through the at least one through hole of the side plate. When the locking member is moved toward the side plate, the securing clip engages with the positioning clip and the at least one locking pin engages into the at least one mounting hole of the data storage device.

Other advantages and novel features will be drawn from the following detailed description of preferred embodiments with attached drawings, in which:

### BRIEF DESCRIPTION OF THE DRAWINGS

FIG. 1 is an exploded, isometric, cutaway view of a mounting apparatus of a preferred embodiment of the present invention, the mounting apparatus including a bracket attached to a computer enclosure, a locking member, and a plurality of springs;

FIG. 2 is an enlarged, isometric view of the bracket of FIG. 1;

FIG. 3 is an enlarged, isometric view of the locking member of FIG. 1, but shown from another aspect;

FIG. 4 is an isometric view of two data storage devices;

FIG. 5 is an assembled view of FIG. 1, showing the locking member in a locked position; and

FIG. 6 is an assembled view of the mounting apparatus and the data storage devices.

### DETAILED DESCRIPTION OF THE INVENTION

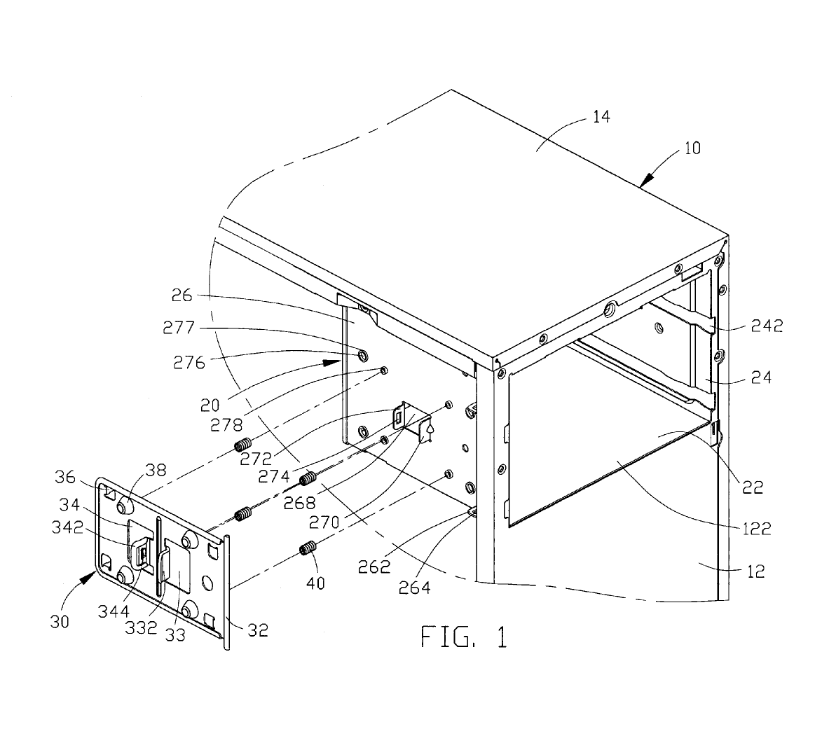

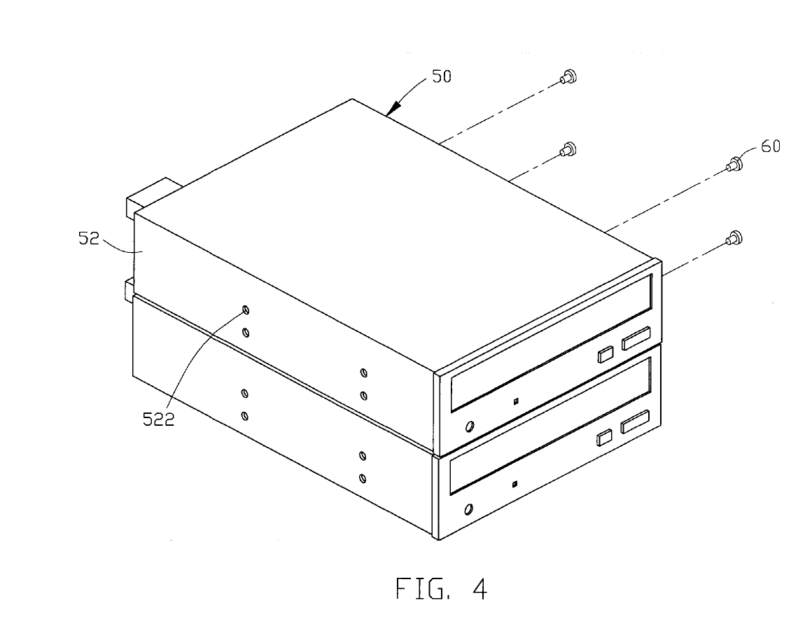

Referring to FIGS. 1 and 4, a mounting apparatus of an electronic device, like a computer, of a preferred embodiment of the present invention is configured for securing functional devices like two data storage devices 50 therein. Each data storage device 50 has a pair of sidewalls 52. A plurality of mounting holes 522 is defined in each sidewall 52. A plurality of mounting members 60 is respectively engagingly received into the mounting holes 522 of one of the sidewalls 52 of each data storage device 50. In this preferred embodiment, the mounting members 60 can be screws. The mounting apparatus includes a bracket 20 attached to a computer enclosure 10 for receiving the data storage devices 50, and a locking member 30 for positioning the data storage devices 50 in the bracket 20.

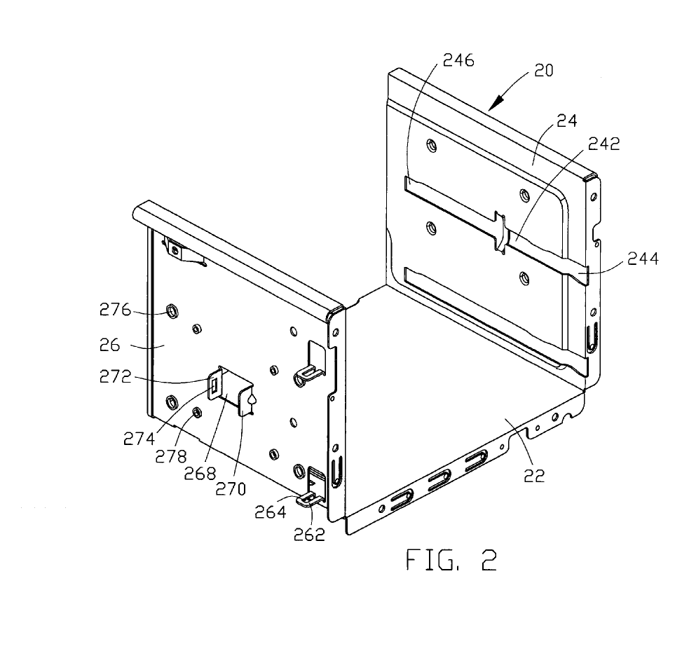

Referring also to FIGS. 1 and 2, the computer enclosure 10 includes a front panel 12 and a top panel 14 perpendicular to the front panel 12. A through opening 122 is defined in the front panel 12 for the data storage devices 50 inserting through. The bracket 20 is secured to the front panel 12 and the top panel 14 of the computer enclosure 10, with rivets, screws, or other mounting means. The bracket 20 includes a bottom plate 22, and a pair of side plates 24, 26 generally perpendicular to the bottom plate 22. Two elongated guiding slots 242 are defined in the side plate 24, for receiving the mounting members 60 of the data storage devices 50. Each guiding slot 242 has an access 244 for the mounting members 60 sliding into the guiding slot 242, and a block end 246 for stopping the mounting members 60. A pair of parallel projecting clips 262 protrudes from the side plate 26, adjacent a front edge of the side plate 26. A through opening 268 is defined in a middle of the side plate 26. A pair of positioning clips 270, 272 is bent out from opposite edges of the through opening 268, and generally parallel to the front edge of the side plate 26. A positioning hole 274 is defined in the positioning clip 272. A through hole 276 and a post 278 are respectively formed at each corner of a rectangular region around the through opening 268. Each positioning hole 274 has an annular flange 277 at an outside surface of the side plate 26.

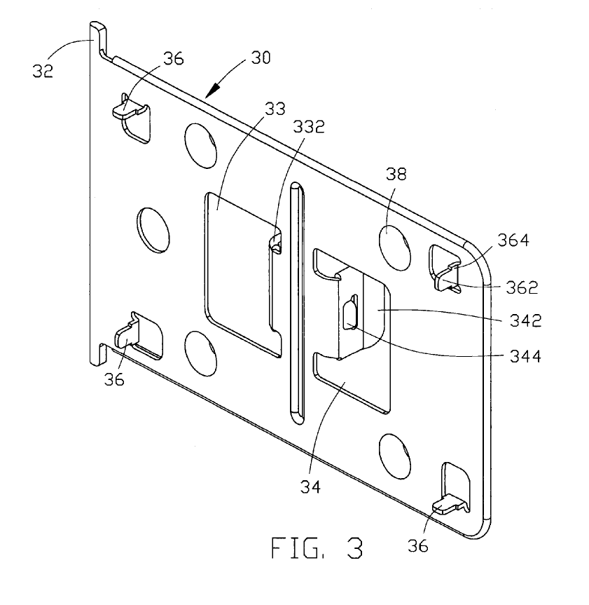

Referring to FIGS. 1 and 3, the locking member 30 is generally rectangular, and forms a pivot shaft 32 at a front edge thereof, corresponding to generally rectangular sliding slots 264 of the projecting clips 262 of the side plate 26 of the bracket 20. Two through openings 33, 34 are defined in the locking member 30, for the positioning clips 270, 272 of the side plate 26 inserting through. A pair of resilient securing clips 332, 342 is bent out from adjacent edges of the through openings 33, 34. A securing protrusion 344 is formed on the securing clip 342, for engaging into the positioning hole 274 of the positioning clip 272 of the side plate 26. A locking pin 36 and a receiving portion 38 are formed on each corner of the locking member 30, corresponding to the through hole 276 and the post 278 of the side plate 26 respectively. Each locking pin 36 includes an inserting portion 362 and a damping portion 364. A width of each damping portion 364 is greater than that of each inserting portion 362, and generally equal to a diameter of each through hole 276 of the side plate 26.

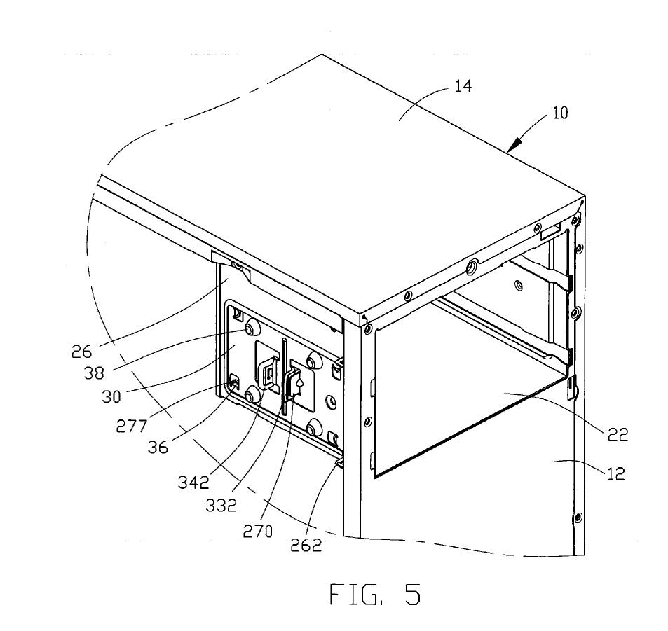

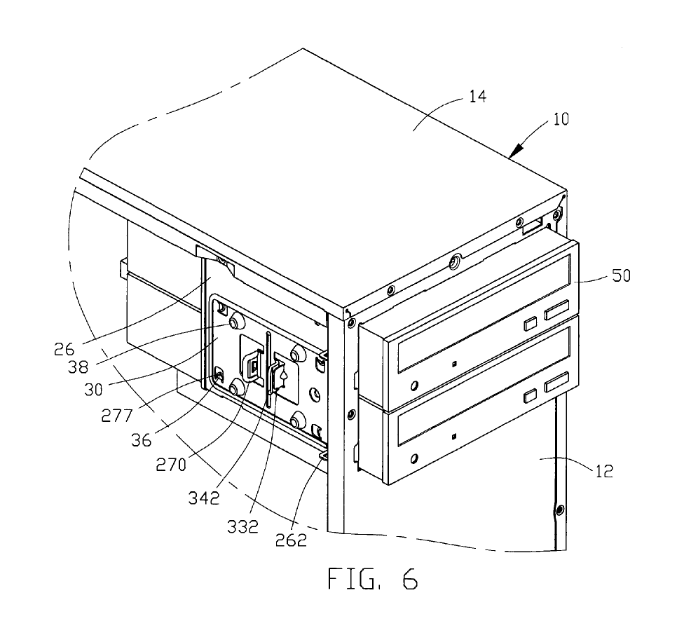

Referring also to FIGS. 5 and 6, in assembly, the shaft 32 of the locking member 30 is engaged into the sliding slots 264 of the projecting clips 262 of the side plate 26 of the bracket 20. The locking member 30 is thereby capable of being rotated about the pivot shaft 32, and slid towards the side plate 26 of the bracket 20 along the sliding slots 264. Then the data storage devices 50 are inserted into the bracket 20 through the through opening 122 of the front panel 12. The mounting members 60 of the data storage devices 50 are slid into the guiding slots 242 of the side plate 24, via the accesses 244. When the mounting members 60 are blocked by the block ends 246 of the guiding slots 242, the mounting holes 522 of the data storage device 50 align with the through holes 276 of the side plate 26. The locking member 30 is then rotated until parallel to the side plate 26 of the bracket 20. The locking pins 36 align with the through holes 276 of the side plate 26, and the positioning clips 270, 272 of the side plate 26 align with the securing clips 332, 342. The locking member 30, still parallel to the side plate 26, is pushed to slide toward the side plate 26, and the locking pins 36 are thereby able to be inserted into the through holes 276 of the side plate 26. The positioning clips 270, 272 insert into the through openings 33, 34 respectively. The securing clips 332, 342 are situated between the positioning clips 270, 272. When the securing protrusion 344 of the securing clip 342 is engaged into the positioning hole 274 of the positioning clip 272, the inserting portions 362 of the locking pins 36 are inserted through the through holes 276 and received into the mounting holes 522 of the data storage devices 50. The securing clips 332, 342 are sandwiched between the securing clips 332, 342. The locking member 30 is positioned on the side plate 26. The data storage devices 50 are therefore secured into the bracket 20. The damping portions 364 of the locking pins 36 abut against inside surfaces of the annular flanges 277 of the through holes 276, in this way, vibrations generated from the data storage devices 50 can be transferred to the bracket 20 of the computer enclosure 10 via the insertion portions 362 and the damping portions 364, thereby reducing the risk of damage to the data storage devices 50.

In removing the data storage devices 50, the securing clips 332, 342 are pressed towards each other, thereby the securing protrusion 344 being detached from the positioning hole 274 of the positioning clip 272. The locking member 30 is slid out, until the locking pins 36 are taken out from the through holes 276 of the side plate 26. The locking member 30 can thus be rotated out, and the data storage devices 50 are thus taken out from the bracket 20.

Referring back to FIG. 1, in this embodiment, a plurality of springs 40 is further provided between the receiving portions 38 of the locking member 30 and the posts 278 of the side plate 26 of the bracket 20. When the data storage devices 50 are secured into the bracket 20, the springs 40 are compressed between the locking member 30 and the side plate 26. Accordingly, in removal of the data storage devices 50, the locking member 30 is urged to slide away from the side plate 26, in a parallel orientation to the side plate 26, by rebounding of the springs 40 when the securing protrusion 344 disengages from the positioning hole 274.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mounting apparatus for a data storage device, at least one mounting hole defined in the data storage device, the mounting apparatus comprising:
a bracket for accommodating the data storage device, the bracket comprising a side plate, at least one through hole defined in the side plate, a positioning clip formed on the side plate; and
a locking member pivotably attached to the side plate for securing the data storage device in the bracket, a resilient securing clip formed on the locking member for engaging with the positioning clip, at least one locking pin formed on the locking member for engaging into the at least one mounting hole of the data storage device through the at least one through hole of the side plate;
wherein when the locking member is moved toward the side plate, the securing clip engages with the positioning clip and the at least one locking pin engages into the at least one mounting hole of the data storage device.

2. The mounting apparatus as described in claim 1, wherein the positioning clip of the side plate defines a positioning hole therein, and the securing clip forms a securing protrusion thereon for engaging into the positioning hole.

3. The mounting apparatus as described in claim 1, wherein a shaft is formed on the locking member, and a pair of projecting clips protrudes from the side plate, each of the projecting clips has a sliding slot defined therein for guidably receiving the shaft of the locking member.

4. The mounting apparatus as described in claim 3, wherein the sliding slots are generally rectangular, and the shaft is capable of sliding towards the side plate along the sliding slot.

5. The mounting apparatus as described in claim 1, wherein a plurality of springs is disposed between the locking member and the side plate for pushing the locking member to slide away from the side plate, in a parallel orientation to the side plate, when the securing clip disengages from the positioning clip.

6. The mounting apparatus as described in claim 1, wherein the at least one locking pin comprises an inserting portion and a damping portion which has a width greater than that of the inserting portion, but generally equal to a diameter of the at least one through hole.

7. The mounting apparatus as described in claim 6, wherein the at least one through hole of the side plate has an annular flange, and the damping portion of the at least one locking pin abuts against the annular flange for reducing the risk of damage to the data storage device.

8. A mounting apparatus for a data storage device with at least one mounting hole defined, comprising:
a bracket for accommodating the data storage device, the bracket comprising a side plate, a through hole defined in the side plate;
a locking member attached to the side plate for securing the data storage device in the bracket, at least one locking pin formed thereon corresponding to the at least one mounting hole; and
a sliding mechanism disposed on the side plate and the locking member, the sliding mechanism comprising a shaft and a pair of sliding slots receiving the shaft and guiding movement of the shaft;
wherein the locking member is capable of being rotated about the shaft until the at least one locking pin aligns with the at least one through hole of the side plate, the locking member is pushed towards the side plate in a manner of being parallel to the side plate, and the at least one locking pin is able to be inserted into the at least one through hole for engaging into the at least one mounting hole to secure the data storage device in the bracket.

9. The mounting apparatus as described in claim 8, wherein the at least one through hole of the side plate has an annular flange, and the at least one locking pin comprises an inserting portion and a damping portion which has a width greater than that of the inserting portion, but generally equal to a diameter of the at least one through hole.

10. The mounting apparatus as described in claim 9, wherein the at least one through hole of the side plate has an annular flange, and the damping portion of the at least one locking pin abuts against inside surface of the annular flange for reducing the risk of damage to the data storage device.

11. The mounting apparatus as described in claim 8, further comprising a positioning mechanism disposed on the locking member and the side plate, the positioning mechanism comprising a positioning hole and a securing protrusion for engaging into the positioning hole to secure the locking member on the side plate.

12. The mounting apparatus as described in claim 11, wherein a pair of positioning clips is formed on the side plate, and a pair of securing clips protrudes from the locking member, one of the positioning clips defines the positioning hole therein, and the securing protrusion is formed on one of the securing clips.

13. The mounting apparatus as described in claim 12, wherein a plurality of springs is disposed between the locking member and the side plate for pushing the locking member to slide away from, while parallel to, the side plate when the securing clip disengages from the positioning clip.

14. The mounting apparatus as described in claim 8, wherein the shaft is formed on the locking member, and a pair of projecting clips protrudes from the side plate, the sliding slots are defined in the projecting clips for receiving the shaft of the locking member.

15. The mounting apparatus as described in claim 13, wherein the sliding slot is generally rectangular, and the shaft slides towards the side plate along the sliding slot.

16. An electronic device comprising:
an enclosure of said electronic device;
a bracket installable in said enclosure and defining a space therein, at least one projecting clip extending from said bracket outside said space;
a functional device removably installable in said space of said bracket so as to provide extensive function for said electronic device in said enclosure; and
a locking member movably attachable to said bracket beside said at least one projecting clip of said bracket, and comprising at least one locking pin reachably extending into said space in order for securing said functional device in said bracket when said locking member moves to a closer position thereof relative to said bracket, said locking member movably engagable with said at least one projecting clip of said bracket so as to maintain attachment thereof to said bracket, and to perform respectively linear and rotary movements thereof relative to said bracket.

17. The electronic device as described in claim 16, wherein a sliding slot is formed in each of said at least one projecting clip so as to guidably receive a shaft formed from said locking member therein.

18. The electronic device as described in claim 16, wherein said locking member is resiliently controllable by at least one spring in said closer position thereof, and is movable from said closer position thereof toward a farther position thereof away from said bracket where said locking member is free from resilient control of said at least one spring.
